(19) United States
(12) Patent Application Publication
(10) Pub. No.: US 2013/0335415 A1
(43) Pub. Date: Dec. 19, 2013

(54) CONVERGED SECURITY MANAGEMENT SYSTEM AND METHOD

(71) Applicant: ELECTRONICS AND TELECOMMUNICATIONS RESEARCH INSTITUTE, (US)

(72) Inventor: Beom Hwan CHANG, Daejeon (KR)

(73) Assignee: ELECTRONICS AND TELECOMMUNICATIONS RESEARCH INSTITUTE, Daejeon (KR)

(21) Appl. No.: 13/727,446

(22) Filed: Dec. 26, 2012

(30) Foreign Application Priority Data
Jun. 13, 2012 (KR) 10-2012-0063247

(51) Int. Cl. G06T 17/05

(52) U.S. Cl. CPC G06T 17/05
USPC 345/420

(57) ABSTRACT

A converged security management system includes a geographical information optimization converter for converting pieces of geographical information collected for converged security management into a data format for high-speed rendering; a three-dimensional (3D) object model generator for generating security facilities that are a subject of the converged security management in a 3D object model like a real object; and a 3D realistic user interface for displaying the security facilities that are the subject of the converged security management using the pieces of geographical information and the 3D object model in a 3D object, receiving an security event from a physical or Information Technology (IT) security sensor, mapping the security event to the 3D object, and displaying a security situation.

### CROSS-REFERENCE TO RELATED APPLICATION(S)

The present invention claims priority of Korean Patent Application No. 10-2012-0063247, filed on Jun. 13, 2012, which is incorporated herein by reference.

### FIELD OF THE INVENTION

The present invention relates to security management using a three-dimensional (3D) object; and more particularly, to a converged security management system and method, which are capable of checking the time when security invasion occurs and the place where security invasion occurs rapidly and early and transferring security situation information to a user more realistically in real time converged security management.

### BACKGROUND OF THE INVENTION

In the case of recent industrial facilities in which persons, pieces of information, infrastructure, and systems are organically combined, physical spaces and cyber spaces are still in the existence. Threats to the information assets of industrial facilities cannot be prevented by fragmentary techniques, such as the existing physical security and IT security techniques, because the drainage of internal assets in physical spaces through portable storage media and the invasion of outsiders and information leaks through cyber spaces, such as hacking, warm viruses, and malicious bots, are generated at the same time.

Accordingly, in order to protect the information assets of industrial facilities, there is a need for a converged security management technique for managing and controlling an invasion accident by organically integrating physical spaces (industrial facility sites) and cyber IT spaces.

In line with the need, there are being developed a method of controlling and monitoring access to a physical space and a cyber space using an integrated authentication card (e.g., a smart card) for the entrance and exist of IT security and physical security, a method of showing simple statistical security events that occur in spaces, or a method of displaying events by listing assets and systems logically.

The conventional security methods are problematic in that the existing infrastructure has to be fully changed, security events occurring in spaces and the activities of users in a cyber space and a physical space need to be monitored using an external Identity Management (IdM) system, and a user needs to interpret an invasion accident again because of the shortage of the intuition of a user interface.

Furthermore, the methods may not be used to warn an invasion accident in its early stage and take accurate and rapid measures because they are used to monitor only a security situation based on information on virtual spaces, but cannot be used to recognize intuitional security situations based on realistic real spaces.

### SUMMARY OF THE INVENTION

In view of the above, the present invention provides a converged security management system and method, which are capable of checking the time when security invasion occurs and the place where security invasion occurs rapidly and early and transferring security situation information to a user more realistically in real time in such a manner that the security events of an IT space and a physical space are made real spaces realistically by optimizing a large amount of geographical information and information, such as aerial images, for the physical space or the IT space, that is, the subject of converged security management, according to LoD levels through high-speed rendering and a 3D object model, 2D image information, 3D object location information, a variety of security events, and various pieces of invasion accident information are displayed by mapping them to real objects in controlling security invasion accidents occurring in an environment in which the physical space and the IT space are converged.

In accordance with a first aspect of the present invention, there is provided a converged security management system, including: a geographical information optimization converter configured to convert pieces of geographical information collected for converged security management into a data format for high-speed rendering; a three-dimensional (3D) object model generator configured to generate security facilities that are a subject of the converged security management in a 3D object model like a real object; and a 3D realistic user interface configured to display the security facilities that are the subject of the converged security management using the pieces of geographical information and the 3D object model in a 3D object, receive an security event from a physical or Information Technology (IT) security sensor, map the received security event to the 3D object, and display a security situation.

Further, the geographical information optimization converter may generate an index grid in which an area that is the subject of the converged security management in a specific number and may generate a data file for geographical information corresponding to an individual index classified by the index grid.

Further, the pieces of geographical information may comprise one or more of topographical information, an aerial image, and a vector type electronic map.

Further, the pieces of geographical information may have a feature that Level of Detail (LoD) level is assigned thereto according to a location of an eye of a user and they are converted without a visual loss.

Further, the security facilities may comprise physical facilities or IT facilities that are the subject of the converged security management.

Further, the physical facilities may comprise all physical facilities in industrial or business sites.

Further, the IT facilities may comprise one or more of infrastructure, persons, information assets, and systems in industrial or business sites.

Further, the 3D realistic user interface may move a focus to a location of the 3D object of the real object where the security event has been generated to display a dangerous situation.

Further, the 3D realistic user interface may display situations of a security camera for capturing an image of the security facilities that are the subject of the converged security management while sequentially moving the situations and may record a moving object in a still image form when detecting the moving object.

In accordance with a second aspect of the present invention, there is provided a converged security management method, including: converting pieces of geographical information collected for converged security management into a data format for high-speed rendering; generating security facilities that are a subject of the converged security management in a three-dimensional (3D) object model like a real object; displaying the security facilities that are the subject of the converged security management in a 3D object using the pieces of geographical information and the 3D object model; and receiving a security event from a physical or Information Technology (IT) security sensor, mapping the security event to the 3D object, and displaying a security situation.

Further, said converting pieces of geographical information into a data format for high-speed rendering may comprise collecting a large amount of basic data for the security facilities that are the subject of the converged security management; dividing a large amount of the collected basic data for each Level of Detail (LoD) level and packaging the divided basic data; and performing triangulation on the data for the security facilities based on a vector type electronic map and packaging the triangulated data.

Further, said generating security facilities in a three-dimensional (3D) object model may comprise generating the 3D object model by rendering the converted map information data and information on the 3D object model of a real space to a realistic 3D space at a high speed.

Further, the pieces of geographical information may comprise one or more of topographical information, an aerial image, and a vector type electronic map.

Further, the pieces of geographical information may have a feature that Level of Detail (LoD) levels are assigned thereto according to a location of an eye of a user and they are converted without a visual loss.

Further, the security facilities may comprise physical facilities or IT facilities that are the subject of the converged security management.

Further, the physical facilities may comprise all physical facilities in industrial or business sites.

Further, the IT facilities may comprise one or more of infrastructure, persons, information assets, and methods in industrial or business sites.

Further, said displaying a security situation may be performed such that a focus is moved to a location of the 3D object to which the real object has been mapped where the security event has been generated and a dangerous situation is displayed.

In accordance with the present invention, the security events of an IT space and a physical space are made real spaces realistically by optimizing a large amount of geographical information and information such as aerial images, for the physical space or the IT space, that is, the subject of converged security management, according to LoD levels through high-speed rendering and a 3D object model, 2D image information, 3D object location information, a variety of security events, and various pieces of invasion accident information are displayed by mapping them to real objects in controlling security invasion accidents occurring in an environment in which the physical space and the IT space are converged. Accordingly, the time when security invasion occurs and the place where security invasion occurs can be checked rapidly and early and security situation information can be transferred to a user more realistically in real time.

Furthermore, the attributes of security events reported by the security sensors in a variety of industrial sites (physical/IT spaces) in which persons, pieces of information, infrastructure, and systems are organically combined and the locations where the security events are generated are mapped to real objects or business regions and are displayed on a real space interface screen using geographical information. Accordingly, a user can rapidly recognize security situation information associated with the time and space and corresponding measures can be automatically performed.

Furthermore, a user can recognize a security situation in a converged real environment precisely as compared with security management of a single space or security management of physical/IT integrated environments and real-time measures according to a security situation can be enabled.

Furthermore, the security of a physical space with the security of an IT space is mapped to and associated with information on a real space, that is, a space to be managed, using the place where a security event occurs and the attributes of the security event and displayed. Accordingly, a user's intuitional recognition can be maximized. Furthermore, there are advantages in that information assets within industrial facilities and a variety of adjacent security situations can be effectively monitored at the same time using the plurality of security sensors because a security event is monitored based on real space information and security situations can be tracked and handled.

Furthermore, invasion accidents, such as an insider invasion accident that cannot be detected by only the security of an individual space (e.g., illegal ID misappropriation), use of a door using an illegal ID card, security situations in a variety of business regions, and a deviation from the moving path of a visitor can be easily recognized because complex security situation information is generated by converting physical security and IT security based on a real space. Accordingly, integrity and substantiality with a real space can be secured by associating unrealistic IT security with a physical space, and security events in physical/IT spaces can be monitored and managed by mapping the security events in physical/IT spaces to on-site information asset objects. Accordingly, danger of security can be recognized and handled in advance.

### BRIEF DESCRIPTION OF THE DRAWINGS

The objects and features of the present invention will become apparent from the following description of embodiments given in conjunction with the accompanying drawings, in which:

FIG. 1 is a detailed block diagram of a converged security management system in accordance with an embodiment of the present invention;

FIGS. 2A to 2C are exemplary diagrams of an index grid, the size and number of topographical blocks, and an area file structure in accordance with an embodiment of the present invention, respectively;

FIGS. 3A and 3B are exemplary diagrams of a topographical altitude data format and an aerial image data format for topographical block mapping in accordance with an embodiment of the present invention, respectively;

FIGS. 4A to 4C are exemplary diagrams of building matching, polygon triangulation, and the generation of walls of a building in a topographical block in accordance with an embodiment of the present invention, respectively;

FIG. 5 is an exemplary diagram of a vector type building object data structure in accordance with an embodiment of the present invention;

FIG. 6 is an exemplary diagram of the management of the exterior and interior of a building in a 3D object model generator in accordance with an embodiment of the present; and

FIGS. 7A and 7B are exemplary diagrams of a 3D realistic user interface in accordance with an embodiment of the present invention.

### DETAILED DESCRIPTION OF THE EMBODIMENTS

Hereinafter, embodiments of the present invention will be described in detail with reference to the accompanying drawings which form a part hereof.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

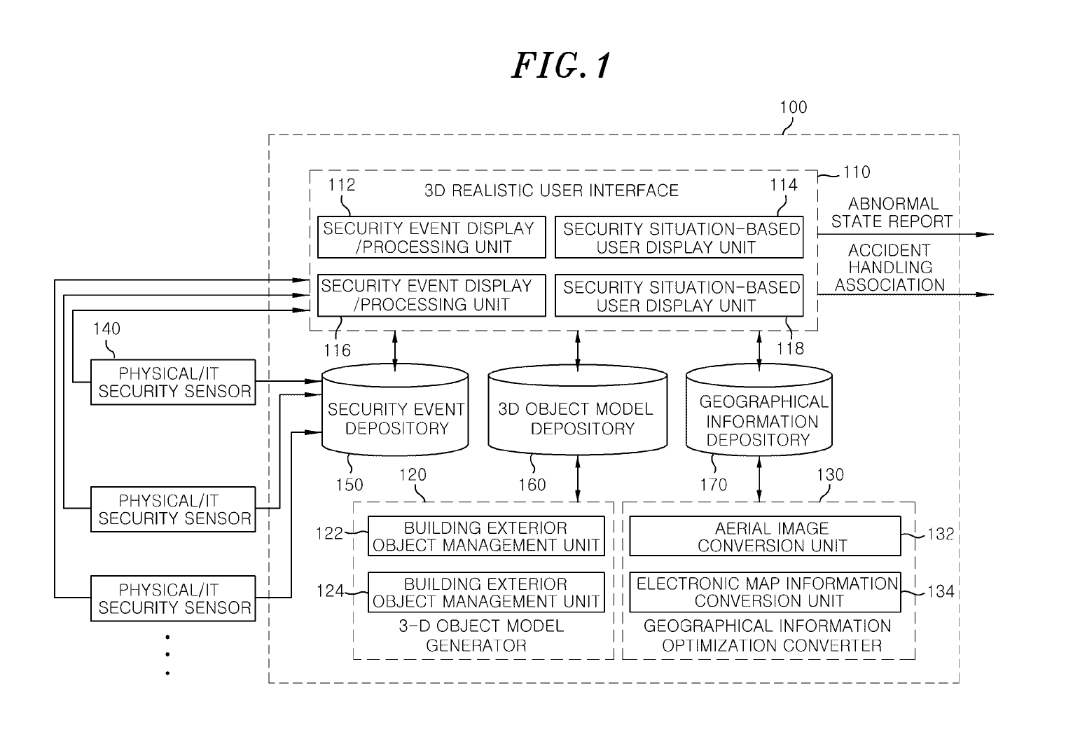

FIG. 1 is a detailed block diagram of a converged security management system 100 using a 3D realistic user interface in accordance with an embodiment of the present invention. The converged security management system 100 includes a 3D realistic user interface 110, a 3D object model generator 120, a geographical information optimization converter 130, a security event depository 150, a 3D object model depository 160, and a geographical information depository 170.

The operations of the elements of the converged security management system in accordance with the present invention are described in detail below with reference to FIG. 1.

First, the geographical information optimization converter 130 converts a large amount of geographical information, used in the 3D realistic user interface 110, into a data format optimized for high-speed rendering.

The converted geographical information includes topographical (altitude value) information, aerial images, and information on a vector type electronic map (e.g., administrative district boundaries, building, roads, and rivers). Here, a LoD level is assigned to the geographical information according to the location of an eye of a user who sees a computer screen, and the geographical information is converted without a visual loss, packaged, and then stored in the geographical information depository 170. For example, if an original geographical information file of 400 MB for a 5 m-level topographical (altitude value) file size that covers the entire area of Jeju-do in Korea, 40 GB for a 51 cm-aerial image file size, or 100 MB for an electronic map file size is used in order to perform converged security management on industrial facilities in Jeju-do through a realistic interface using geographical information, real-time rendering is impossible in a 3D user interface.

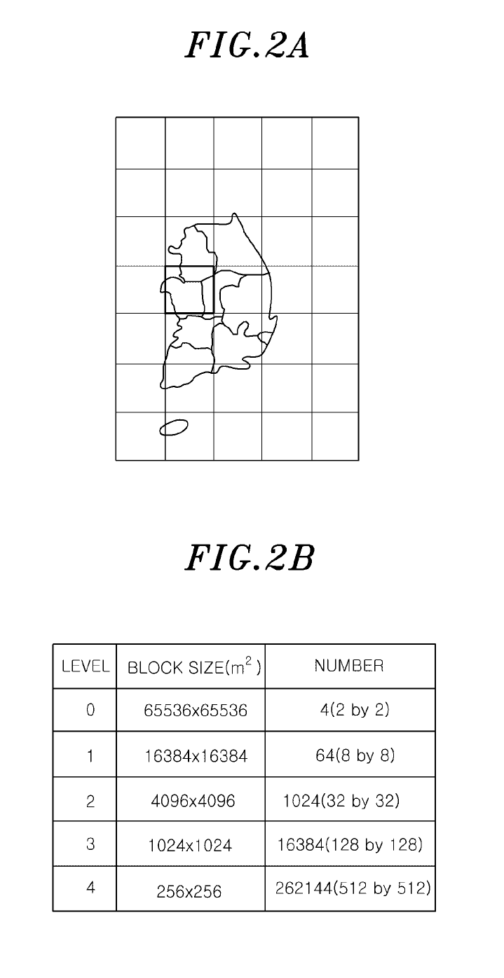

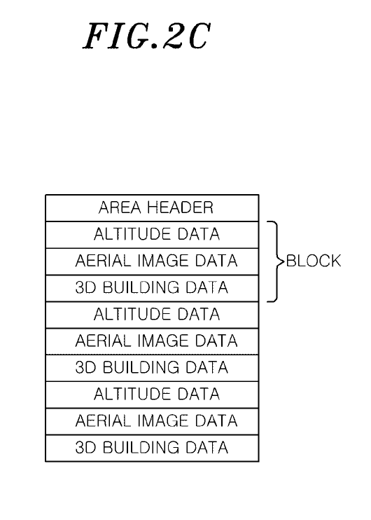

FIGS. 2A to 2C show examples in which the geographical information optimization converter 130 performs geographical information optimization conversion. In particularly, FIGS. 2A to 2C illustrate a geographical information optimization conversion concept for converged security management on industrial facilities in Daejeon of Korea.

The geographical information optimization converter 130 performs geographical information optimization conversion as shown in FIGS. 2A to 2C in order to perform converged security management on the industrial facilities of Daejeon in Korea. First, an index grid is generated by dividing all parts of the country into a total of 35 (5×7) in normalization coordinate systems on the basis of the original point of the central district of Korea, and geographical information data files corresponding to respective indices are generated for each level by applying the LoD algorithm to the indices. Each of index regions divided in the index grid is defined as “AREA”, and the index regions are sequentially assigned identifiers of to 34 from the left bottom side to the top and right directions. Accordingly, an area of each AREA is 131.072 km², and the Daejeon district is No. 10 AREA. Likewise, the geographical information data of the AREAs are classified into topographical blocks according to the LoD levels and then packaged. FIGS. 2B and 2C respectively show the size and number of topographical blocks, and an AREA file structure when the LoD is classified into 5 levels.

The geographical information optimization converter 130 includes a topographical, altitude, and aerial image conversion unit 132 and an electronic map information conversion unit 134. The topographical, altitude, and aerial image conversion unit 132 performs conversion on topographical, altitude, and aerial image information on an area on which converged security management has to be performed. The electronic map information conversion unit 134 performs conversion on electronic map information on an area on which converged security management has to be performed.

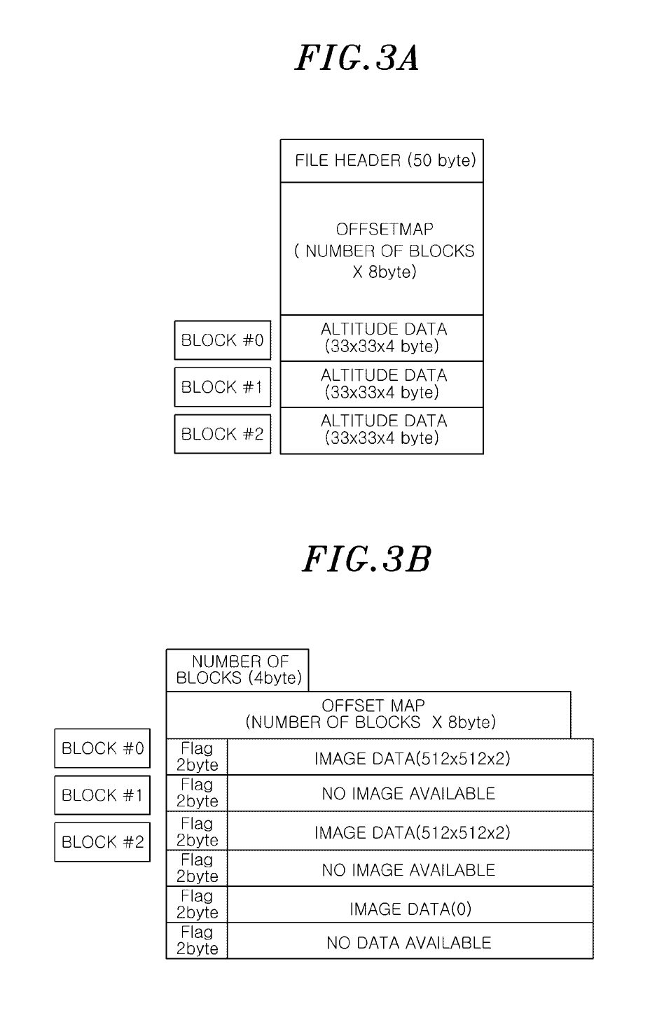

FIGS. 3A and 3B are exemplary diagrams of a topographical altitude data format and an aerial image data format for topographical block mapping in accordance with an embodiment of the present invention, respectively.

Referring to FIGS. 3A and 3B, topographical altitude data and aerial image data are clipped and packaged for each LoD level. A Digital Elevation Model (DEM) is used in the topographical altitude data, and image files, such as JPG, BMP, IMG, and TIFF, are used in the aerial image data.

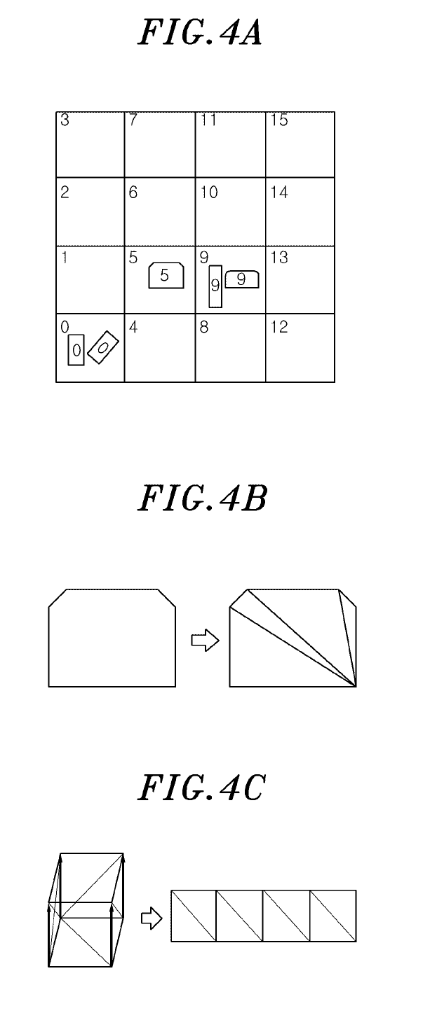

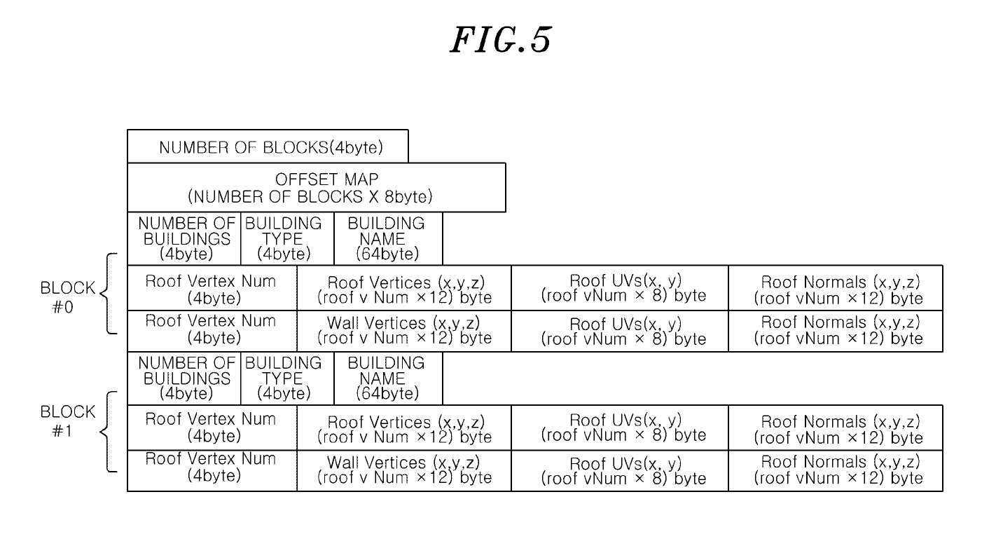

FIGS. 4A and 4C illustrate a method of matching a 2D building floor (i.e., polygon) which may be referred in a vector type electronic map file to a topographical block, a method of generating a roof by performing triangularization on the polygon for high-speed rendering, and a method of generating the walls of a building using height values and performing conversion into a 3D building object respectively. Here, the walls of the building are formed of triangle strips by taking performance into account.

FIG. 5 illustrates a vector type 3D building object data structure that is converted and generated by the geographical information optimization converter 130.

The 3D object model generator 120 functions to generate facilities, infrastructure, persons, information assets, and systems in industrial/business sites, that is, the subject of security management and control, in a 3D model form like a real object, store them in the 3D object model depository 160 so that they are used in the 3D realistic user interface 110, and manage (modify and edit) a 3D object produced in an exterior 3D object creation tool. A building exterior object management unit 122 manages objects outside security facilities, that is, the subject of converged security management. A building interior object management unit 124 manages objects inside security facilities, that is, the subject of converged security management.

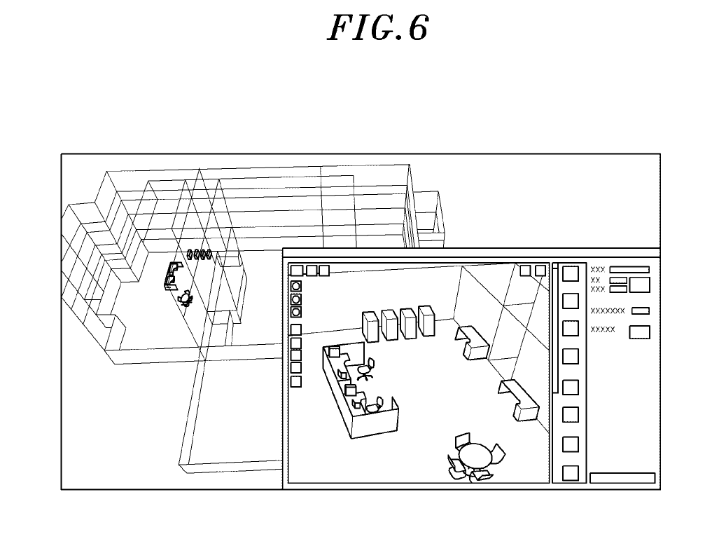

FIG. 6 shows an example in which the 3D object model generator 120 has performed a 3D object modeling on the security facilities, that is, the subject of converged security management, and illustrates that the exterior of a building is designed and generated and the interior of the building is edited and managed using a variety of assets.

Here, the security facilities may comprise physical facilities or IT facilities that are the subject of converged security management. Further, the physical facilities may comprise all physical facilities in industrial or business sites, and the IT facilities may comprise one or more of infrastructure, persons, information assets and systems in industrial or business sites.

The 3D realistic user interface 110 displays industrial/business sites realistically using the geographical information of the geographical information depository 170, the vector type electronic map information, and the 3D object model of the 3D object model depository 160 and displays a security situation by mapping security events from external physical/IT security sensors 140 or security events stored in the security event depository 150 to the 3D object.

A security event display/processing unit 112 processes security events received from the physical/IT security sensors 140 and displays the processed security events. A security event reception/analysis unit 116 receives security events from the physical/IT security sensors 140, stores the received security events in the security event depository 150, and analyzes the contents of the security events. A security situation-based user display unit 114 displays user information on the analyzed security events.

A geographical information and object model display unit 118 displays a security event by mapping geographical information on a corresponding area where the security event occurred from the geographical information depository 170 and the 3D object model depository 160 to the 3D object model.

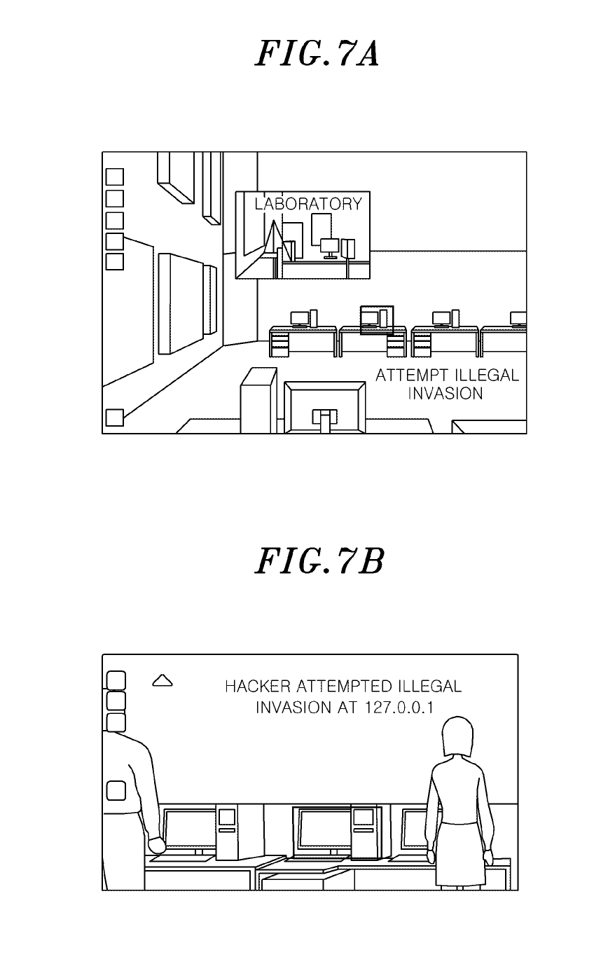

FIGS. 7A and 7B show examples of converged security management that are generated from the 3D realistic user interface 110. When an abnormal phenomenon or a dangerous security event occurs, a focus is moved to the location of a real object that is mapped to the security event through zoom-in and zoom-out, and the dangerous situation is displayed, and image information, such as an IP camera, can always be projected to the wall of a building or an actual location and textured on real objects, thus becoming real spaces. There are a function of capturing a moving object while a situation at a place where a camera is placed is sequentially moved and displayed using an unmanned automation method at night or a desolate place, storing an image of the captured object as a still image, and reporting it to a user and a function of reporting it to an external response-associated system depending on the type of security situation, such as an security event defined by a user or the occurrence of an invasion accident.

As described above, in accordance with the present invention, the security events of an IT space and a physical space are made real spaces realistically by optimizing a large amount of geographical information and information, such as aerial images, for the physical space or the IT space, that is, the subject of converged security management, according to LoD levels through high-speed rendering and a 3D object model, 2D image information, 3D object location information, a variety of security events, and various pieces of invasion accident information are displayed by mapping them to real objects in controlling security invasion accidents occurring in an environment in which the physical space and the IT space are converged. Accordingly, there are advantageous in that the time when security invasion occurs and the place where security invasion occurs can be checked rapidly and early and security situation information can be transferred to a user more realistically in real time.

Furthermore, in accordance with the present invention, the attributes of security events reported by the security sensors in a variety of industrial sites (physical/IT spaces) in which persons, pieces of information, infrastructure, and systems are organically combined and the locations where the security events are generated are mapped to real objects or business regions and are displayed on a real space interface screen using geographical information. Accordingly, there are advantages in that a user can rapidly recognize security situation information associated with the time and space and corresponding measures can be automatically performed.

Furthermore, there are advantages in that a user can recognize a security situation in a converged real environment precisely as compared with security management of a single space or security management of physical/IT integrated environments and real-time measures according to a security situation are possible. Furthermore, the security of a physical space with the security of an IT space is mapped to and associated with information on a real space, that is, a space to be managed, using the place where a security event occurs and the attributes of the security event and displayed. Accordingly, a user's intuitional recognition can be maximized. Furthermore, there are advantages in that information assets within industrial facilities and a variety of adjacent security situations can be effectively monitored at the same time using the plurality of security sensors because a security event is monitored based on real space information and security situations can be tracked and handled.

Furthermore, invasion accidents, such as an insider invasion accident that cannot be detected by only the security of an individual space (e.g., illegal ID misappropriation), use of a door using an illegal ID card, security situations in a variety of business regions, and a deviation from the moving path of a visitor can be easily recognized because complex security situation information is generated by converting physical security and IT security based on a real space. Accordingly, integrity and substantiality with a real space can be secured by associating unrealistic IT security with a physical space, and security events in physical/IT spaces can be monitored and managed by mapping the security events in physical/IT spaces to on-site information asset objects. Accordingly, a danger of security can be recognized and handled in advance.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A converged security management system, comprising:
a geographical information optimization converter configured to convert pieces of geographical information collected for converged security management into a data format for high-speed rendering;
a three-dimensional (3D) object model generator configured to generate security facilities that are a subject of the converged security management in a 3D object model like a real object; and
a 3D realistic user interface configured to display the security facilities that are the subject of the converged security management using the pieces of geographical information and the 3D object model in a 3D object, receive an security event from a physical or Information Technology (IT) security sensor, map the received security event to the 3D object, and display a security situation.

2. The converged security management system of claim 1, wherein the geographical information optimization converter generates an index grid in which an area that is the subject of the converged security management in a specific number and generates a data file for geographical information corresponding to an individual index classified by the index grid.

3. The converged security management system of claim 1, wherein the pieces of geographical information comprise one or more of topographical information, an aerial image, and a vector type electronic map.

4. The converged security management system of claim 3, wherein the pieces of geographical information has a feature that Level of Detail (LoD) level is assigned thereto according to a location of an eye of a user and they are converted without a visual loss.

5. The converged security management system of claim 1, wherein the security facilities comprise physical facilities or IT facilities that are the subject of the converged security management.

6. The converged security management system of claim 5, wherein the physical facilities comprise all physical facilities in industrial or business sites.

7. The converged security management system of claim 5, wherein the IT facilities comprise one or more of infrastructure, persons, information assets, and systems in industrial or business sites.

8. The converged security management system of claim 1, wherein the 3D realistic user interface moves a focus to a location of the 3D object of the real object where the security event has been generated to display a dangerous situation.

9. The converged security management system of claim 1, wherein the 3D realistic user interface displays situations of a security camera for capturing an image of the security facilities that are the subject of the converged security management while sequentially moving the situations and may record a moving object in a still image form when detecting the moving object.

10. A converged security management method, comprising:
converting pieces of geographical information collected for converged security management into a data format for high-speed rendering;
generating security facilities that are a subject of the converged security management in a three-dimensional (3D) object model like a real object;
displaying the security facilities that are the subject of the converged security management in a 3D object using the pieces of geographical information and the 3D object model; and
receiving a security event from a physical or Information Technology (IT) security sensor, mapping the security event to the 3D object, and displaying a security situation.

11. The converged security management method of claim 10, wherein said converting pieces of geographical information into a data format for high-speed rendering comprises:
collecting a large amount of basic data for the security facilities that are the subject of the converged security management;
dividing a large amount of the collected basic data for each Level of Detail (LoD) level and packaging the divided basic data; and
performing triangulation on the data for the security facilities based on a vector type electronic map and packaging the triangulated data.

12. The converged security management method of claim 10, wherein said generating security facilities in a three-dimensional (3D) object model comprises generating the 3D object model by rendering the converted map information data and information on the 3D object model of a real space to a realistic 3D space at a high speed.

13. The converged security management method of claim 10, wherein the pieces of geographical information comprise one or more of topographical information, an aerial image, and a vector type electronic map.

14. The converged security management method of claim 10, wherein the pieces of geographical information has a feature that Level of Detail (LoD) levels are assigned thereto according to a location of an eye of a user and they are converted without a visual loss.

15. The converged security management method of claim 10, wherein the security facilities comprise physical facilities or IT facilities that are the subject of the converged security management.

16. The converged security management method of claim 15, wherein the physical facilities comprise all physical facilities in industrial or business sites.

17. The converged security management method of claim 15, wherein the IT facilities comprise one or more of infrastructure, persons, information assets, and methods in industrial or business sites.

18. The converged security management method of claim 10, wherein said displaying a security situation is performed such that a focus is moved to a location of the 3D object to which the real object has been mapped where the security event has been generated and a dangerous situation is displayed.
